(19) United States
(12) Patent Application Publication
(10) Pub. No.: US 2025/0247256 A1
(43) Pub. Date: Jul. 31, 2025

(54) Electronic Tethering for Verified Remote Connections

(71) Applicant: Hewlett-Packard Development Company, L.P., Spring, TX (US)

(72) Inventors: Benjamin Christopher Swayne, Burnaby (CA); Geoffrey Anthony Holt, Burnaby (CA); Eli Henry Kaplan, Burnaby (CA); Colin James Young, Burnaby (CA)

(73) Assignee: Hewlett-Packard Development Company, L.P., Spring, TX (US)

(21) Appl. No.: 18/427,690

(22) Filed: Jan. 30, 2024

(51) Int. Cl. H04L 9/32; H04L 9/30; H04W 12/08

(52) U.S. Cl. CPC H04L 9/3271; H04L 9/30; H04W 12/08

(57) ABSTRACT

Systems and methods are provided for electronic tethering for verified remote connections. A device may include a processing system with an electronic processor and a network interface. The processing system may receive a first challenge of a plurality of periodically received challenges from a server system where the first challenge is received via a verified connection to the server system, transmit, wirelessly, the first challenge to an electronic tether, receive, from the electronic tether, a tether response to the first challenge; and maintain the verified connection by transmitting the tether response to the server system.

### BACKGROUND

Devices may be wirelessly connected or coupled to a remote server system using a verified connection over a communication network. To establish the verified connection, devices may undergo a verification process (e.g., using a fingerprint scan, an iris scan, facial recognition, a password, an authentication application, a text message, etc.). This process ensures that a user attempting to access the remote server system is an authorized user. Once the verified connection is established, the user can access the remote server system.

### BRIEF DESCRIPTION OF THE DRAWINGS

The following drawings are provided to help illustrate various features of examples of the disclosure and are not intended to limit the scope of the disclosure or exclude alternative implementations.

FIG. 1 schematically illustrates a system including a device for tethering-based secure remote connections according to some examples.

FIG. 2 schematically illustrates a system including a server for tethering-based secure remote connections according to some examples.

FIG. 3 is a flowchart to illustrate a process for session initiation among an electronic tether, a device, and a server system according to some examples.

FIG. 4 is a flowchart to illustrate a process for ongoing evaluation among an electronic tether, a device, and a server system according to some examples.

FIG. 5 is a flowchart illustrating a method of a device for tethering-based secure remote connections according to some examples.

FIG. 6 is a flowchart illustrating a method of a server for tethering-based secure remote connections according to some examples.

### DETAILED DESCRIPTION OF THE PRESENT DISCLOSURE

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways.

As described above, a verification process may be used to establish a verified connection between the device and the server system. However, in some systems, once the verified connection is established, the server system maintains the verified connection until the device is disconnected from the server system. That is, the verified connection is not terminated even if the device is moved to another place. Thus, theft of the device, which is currently connected to the remote server system, would allow the attacker to fully access the remote server system with the privileges of the legitimate user who established the connection. This may open a significant window of opportunity to steal secrets, move laterally to other systems, or do damage before the legitimate user becomes aware of the theft and takes steps to sever the connection (e.g., by contacting a specialist in the information technology department). Thus, a device, a server system, and/or a method to prevent unauthorized use of an established connection to the server system are in need.

Accordingly, some embodiments disclosed herein may prevent unauthorized use of a verified connection to a remote server system using an electronic tether, also referred to as an electronic trust tether. The electronic tether may be unattached and wirelessly coupled to a device (i.e., client hardware or client device) that has the verified connection to the remote server system, but in close proximity to the device. For example, some embodiments disclosed herein may continuously or periodically evaluate the verified connection of the device to the server system via the electronic tether using a cryptographic challenge/response between the server system and the electronic tether via the client device. Thus, some embodiments disclosed herein may close the time window for the unauthorized use of the device by automatically severing the verified connection as soon as the device moves away from the electronic tether. By preventing the unauthorized use of the verified connection with the disclosed techniques, the verified connection may be a secure connection. The disclosure provides various techniques for the continuous or periodic evaluation of the verified connection between the client device and the server system using the electronic tether.

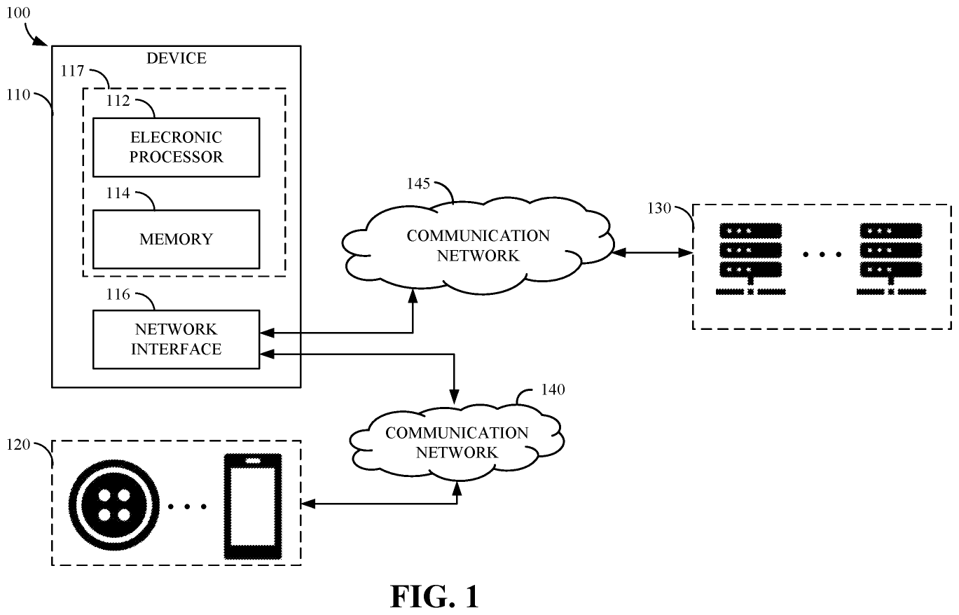

FIG. 1 schematically illustrates a system 100 including a device 110 for tethering-based secure remote connections according to some examples. The system 100 may include a device 110 (also referred to as a client device 110), one or more electronic tethers 120, and a server system 130. In some examples, the device 110 may include a laptop computer, a desktop computer, a minicomputer, a workstation, an all-in-one computer, a mobile phone, a tablet, or any other suitable client device having computing and wireless communication capabilities.

As illustrated in FIG. 1, the device 110 includes an electronic processor 112, a memory 114, and a network interface 116. The electronic processor 112, with or without the memory 114, may be referred to as a processing system 117 of the device 110. The electronic processor 112, the memory 114, and the network interface 116 may communicate with each other wirelessly, over one or more communication lines or buses, or a combination thereof. The device 110 may include additional, different, or fewer components than those illustrated in FIG. 1 in various configurations.

The electronic processor 112 may be any suitable hardware processor or combination of processors, such as, for example, a central processing unit (CPU), a graphics processing unit (GPU), an application specific integrated circuit (ASIC), a field-programmable gate array (FPGA), a digital signal processor (DSP), a microcontroller (MCU), or another suitable electronic device for processing data. Accordingly, the processing system 117 may include one processor or multiple processors. The electronic processor 112 coupled to the memory 114 is configured to retrieve instructions and data from the memory 114 and execute the instructions.

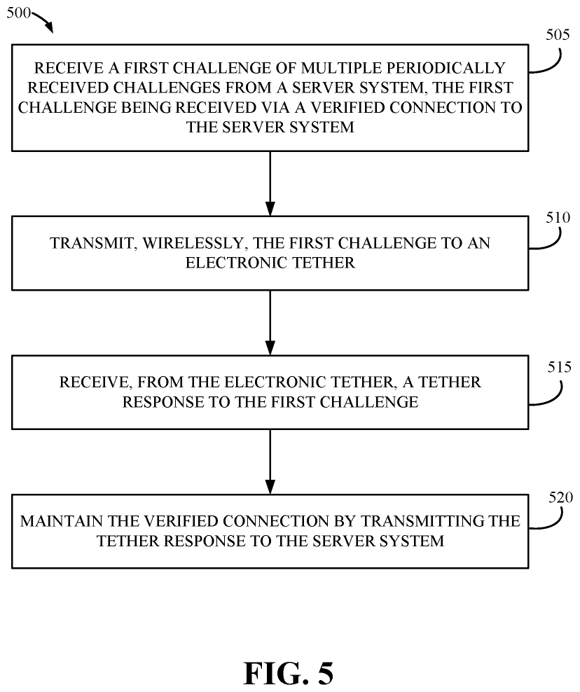

In some examples, the memory 114 may include any suitable non-transitory computer-readable storage device or devices that may be used to store instructions that may can be used, for example, by the electronic processor 112 to receive a first challenge of a plurality of periodically received challenges from a server system, to transmit, wirelessly, the first challenge to an electronic tether, to receive, from the electronic tether, a tether response to the first challenge, to maintain the verified connection by transmitting the tether response to the server system, to lose the verified connection to the server system in response to failing to transmit a second tether response to the server system that is expected based on the second challenge, to receive an invalid tether response to the second challenge, to transmit the invalid tether response to the server system, to terminate the verified connection, causing the verified connection to be lost, in response to failing to receive the second tether response from the electronic tether within a predetermined period of time, to receive a public key from the electronic tether, to transmit the public key and an attribute to the server system, to receive a session key for the verified connection, and/or to transmit the session key to the electronic tether. The memory 114 may include any suitable volatile memory, non-volatile memory, storage, or any suitable combination thereof. For example, the memory 114 may include random access memory (RAM), read-only memory (ROM), electronically-erasable programmable read-only memory (EEPROM), one or more flash drives, one or more hard disks, one or more solid state drives, one or more optical drives, etc. In some embodiments, the memory 114 may have encoded thereon a computer program for executing at least a portion of process 500 described in connection with FIG. 5. For example, in such embodiments, the electronic processor 112 may execute at least a portion of the computer program to perform one or more data processing and/or data transmitting/receiving tasks described herein (e.g., blocks 505-520 of FIG. 5).

The network interface 116 may include any suitable hardware, firmware, and/or software for communicating with the server system 130, one or more electronic tethers 120, and/or another system over a communication network 140, a communication network 145, and/or any other suitable communication networks. For example, the network interface 116 may include one or more transceivers, one or more communication chips and/or chip sets, etc. In a more particular example, the network interface 116 may include hardware, firmware and/or software that may be used to establish a Wi-Fi connection, a Bluetooth® connection, a cellular connection, an Ethernet connection, etc. In some embodiments, the network interface 116 may establish multiple network connections. For example, the network interface 116 coupled to the electronic processor 112 may establish a short-range connection using a short-range wires communication protocol (e.g., Wi-Fi®, Bluetooth®, Zigbee®, Z-Wave®, Thread®, Radio Frequency Identification (RFID), wireless Universal Serial Bus (USB), or any other suitable wireless communication protocol) to be wirelessly coupled to the electronic tether 120. At the same time, the network interface 116 coupled to the electronic processor 112 may establish another short-range connection, a long-range connection using a long-range wireless communication protocol (e.g., cellular communication protocol, LoRa, Sigfox, or any other suitable wireless communication protocol), and/or a wired connection (e.g., using Ethernet cables, telephone lines, television cables, fiber-optic cables, etc.) to be communicationally coupled to the server system 130. In other embodiments, a long-range connection may be used to be wirelessly coupled to the electronic tether 120, and/or a short-range connection can be utilized to be communicationally coupled to the server system 130.

The device 110 may perform additional functionality other than the functionality described herein. For example, the device 110 may further include a display to display any data or information on a display screen, an input (e.g., a keyboard, a mouse, a camara, a touchscreen, a microphone, a game controller, a sensor, etc.) to receive any data or information from the user, an output (e.g., a speaker, a printer, light(s), etc.) to provide any data or information to the user.

The device 110 may communicate, via the network interface 116, with the electronic tether 120 over the communication network 140 and/or the server system 130 over the communication network 145. Portions of the communication network 140 may include a Wi-Fi network (which may include one or more wireless routers, one or more switches, etc.), a peer-to-peer network (e.g., a Bluetooth® network, a Zigbee® network, a Z-Wave® network, a Thread® network, etc.), a cellular network (e.g., a 3G network, a 4G network, a 5G network, etc., complying with any suitable standard, such as, for example, CDMA, GSM, LTE, LTE Advanced, NR, etc.), a wired network, etc. Similarly, portions of the communication network 145 may include a Wi-Fi network (which may include one or more wireless routers, one or more switches, etc.), a peer-to-peer network (e.g., a Bluetooth® network, a Zigbee® network, a Z-Wave® network, a Thread® network, etc.), a cellular network (e.g., a 3G network, a 4G network, a 5G network, etc., complying with any suitable standard, such as, for example, CDMA, GSM, LTE, LTE Advanced, NR, etc.), a wired network, etc. In some examples, the communication network 140 and the communication network 145 may be the same communication network.

The device 110 may be wirelessly coupled to the electronic tether 120 (e.g., using a short-range communication protocol) over the communication network 140. The electronic tether 120 may include an electronic processor, a memory, and/or a network interface to communicate with the device. The electronic processor, the memory, and the network interface of the electronic tether 120 are substantially similar to the electronic processor 112, the memory 114, and the network interface 116 of the device 110 in FIG. 1. The electronic tether 120 may be a mobile device (e.g., a mobile phone, etc.) of a user, an embedded device in personal belongings (e.g., a wallet, a bag, a cloth, etc.) that a user can carry, a physical device, which is physically mounted to a location (e.g., a desk, a wall, etc.) in which the device 110 is expected to be placed (e.g., at a secure room) to access the server system 130. Also, the device 110 may be wirelessly coupled to one electronic tether 120 or multiple electronic tethers 120. Thus, the device 110 may receive and/or transmit data for a verification process from and/or to one electronic tether 120 or multiple electronic tethers 120. The electronic tether 120 may be designed to be placed in close proximity to the device. Thus, the communication protocol may use a short-range communication protocol (e.g., a Wi-Fi protocol, a Bluetooth® protocol, a Zigbee® protocol, a Z-Wave® protocol, a Thread® protocol, a wireless USB protocol, a Radio Frequency Identification (RFID) protocol, etc.).

The device 110 may also be communicationally coupled to the server system 130 (e.g., using a short-range communication protocol, a long-range communication protocol, a wired connection, etc.) over the communication network 145. The server system 130 may include one or more servers. In some examples, the device 110 may perform a verification process with one server and establish a secure and verified connection with the same server. In other examples, the device 110 may perform different processes with multiple servers. For example, the device 110 may establish a verified connection with one server while performing a verification process with another server. In further examples, a server of the server system 130 may store an evaluation policy to verify the connection or another server in the server system 130 may transmit the evaluation policy to the server in the server system 130 to verify the connection. In some examples, the device 110 may support multiple communication protocols (e.g., a communication protocol for communications with the server system 130, a different communication protocol for communications with the electronic tether 120, etc.). The communication protocol for the server system 130 may use the short-range communication protocol, a long-range communication protocol (e.g., a cellular communication protocol, etc.), and/or a wired communication protocol.

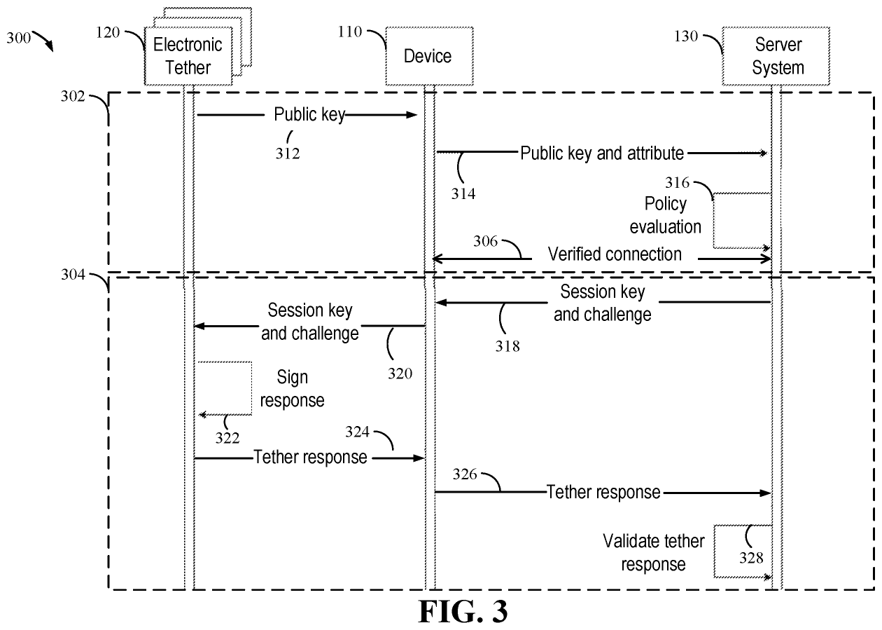

In some examples, the system 100 may include multiple devices 110 wirelessly coupled with the same electronic tether 120. In some examples, the system 100 may include multiple devices 110 each wirelessly coupled to respective electronic tether 120. Each device 110 may utilize a corresponding electronic tether 120 or electronic tethers 120 (whether unique or shared with another device 110) to establish and maintain a verified connection, as described in further detail below (e.g., with respect to FIGS. 3-5).

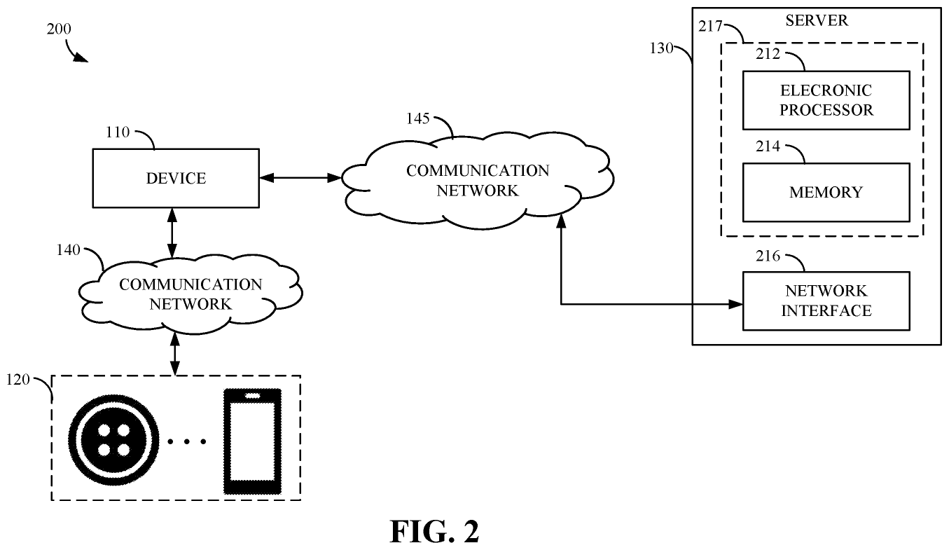

FIG. 2 schematically illustrates a system 200 including a server 130 (or a server system) for tethering-based secure remote connections according to some examples. The system 200 may include a server system 130, a device 110, and one or more electronic tethers 120. In some examples, the server system 130 may include a laptop computer, a desktop computer, a minicomputer, a workstation, a tablet, an all-in-one computer, or any other suitable device having computing and communication capabilities.

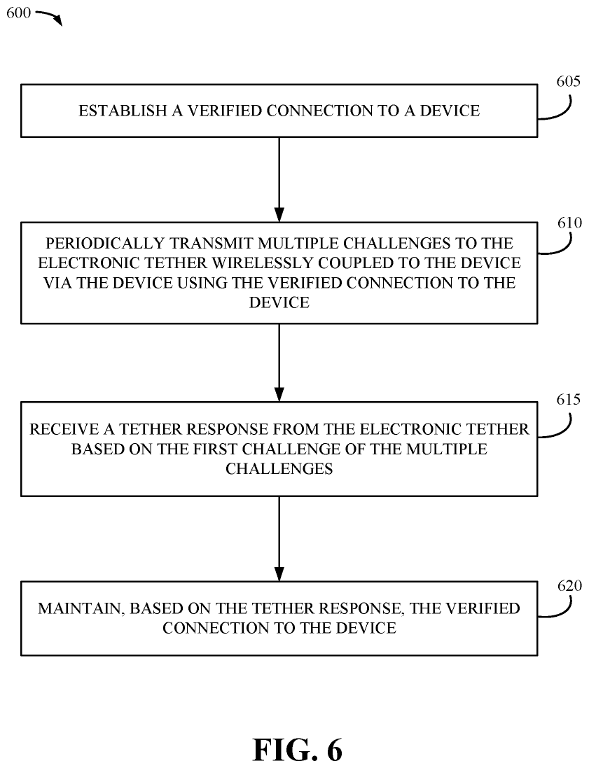

As illustrated in FIG. 2, the server system 130 includes an electronic processor 212, a memory 214, and a network interface 216. In some examples, the electronic processor 212, with or without the memory 214, may be referred to as a processing system 217 of the server system 130. The processing system 217 of the server system 130, and the electronic processor 212 thereof, may include processor(s) of a single server or processors distributed across multiple servers of the server system 130. The electronic processor 212, the memory 214, and the network interface 216 may communicate with each other wirelessly, over one or more communication lines or buses, or a combination thereof. The server system 130 may include additional, different, or fewer components than those illustrated in FIG. 2 in various configurations. In some examples, the electronic processor 212, the memory 214, and the network interface 216 may be substantially similar to the electronic processor 112, the memory 114, and the network interface 116 of the device 110 in FIG. 1. However, the memory 214 may have encoded thereon a computer program for executing at least a portion of process 600 described in connection with FIG. 6. For example, in such embodiments, the electronic processor 212 can execute at least a portion of the computer program to establish a verified connection to a device, to periodically transmit multiple challenges to an electronic tether being wirelessly coupled to the device via the device using the verified connection to the device, to receive a tether response from the electronic tether based on a first challenge of the plurality of challenges, to maintain the verified connection to the device based on the tether response, transmit a second challenge of the multiple challenges, to terminate the verified connection to the device in response to failing to receive a second tether response based on the second challenge within a predetermined period of time, to receive an invalid tether response to the second challenge, to terminate the verified connection to the device in response to the invalid tether response, to receive a public key from the electronic tether via the device, to receive an attribute of the device, to establish the verified connection to the device based on the public key and the attribute, and/or to transmit a session key for the verified connection to the electronic tether via the device described herein.

FIG. 3 is a flowchart to illustrate a process for session initiation among the electronic tether 120, the device 110, and the server system 130 according to some examples. As described below, a particular implementation may omit some or all illustrated features/steps, may be implemented in some embodiments in a different order, and may not require some illustrated features to implement all embodiments.

The session initiation process 300 may include a secure connection establishment process 302 and a connection validation process 304. In the secure connection establishment process 302, a verified connection 306 between the device 110 and the server system 130 may be established based on information from the electronic tether 120 and/or the device 110. In some examples, prior to the secure connection establishment process 302, a pairing process between the electronic tether 120 and the device 110 may be performed. For example, when the device 110 uses the Bluetooth® communication protocol to communicate with the electronic tether 120, the pairing process to communicationally couple the device 110 to the electronic tether 120 may be performed. In some examples, the paring process may be automatically performed when the device 110 is in close proximity to the electronic tether 120.

At step 312, the electronic tether 120 may transmit or broadcast a public key to the device 110, and the device 110 may receive the public key from the electronic tether 120. The public key may include a numerical value to encrypt data. Additionally or alternatively, the public key may include any symbol(s), any character(s), any number, or a combination thereof. In some examples, the device 110 may receive multiple public keys at the same time or periodically from the electronic tether 120 to encrypt data. In further examples, at step 312, the device 110 may receive multiple public keys from multiple electronic tethers 120 to encrypt data. In some scenarios, the public key of the electronic tether 120 may be enrolled or pre-registered (and, thus, shared with) the device 110 and/or the server system 130 before the electronic tether 120 transmits the public key to the device 110. This enrolling or pre-registration may take place via an out-of-band process involving, for example, an administrator. Thus, a Man in the Middle (MITM) attack for a perpetrator to eavesdrop or impersonate communications among the electronic tether 120, the device 110, and the server system 130 may be avoided since the perpetrators public key would not be recognized by the device and/or server system

At step 314, the device 110 may transmit the public key and/or an attribute to the server system 130, and the server system 130 may receive the public key and/or an attribute from the device 110. For example, the attribute may include device specific information of the device 110, user specific information of the user, a user credential, and/or network specific information. For example, the attribute may include an internet protocol (IP) address on which the device 110 is communicationally coupled to the communication network 140, a user identification and a password of the user to try to access the server system 130, device information (e.g., device hardware identification, system information, software information, etc.), and/or any other suitable information associated with the device 110. In some scenarios, step 314 may be similar to a log-on process by providing the user identification and the password to access the server system 130. In some examples, additionally or alternatively, the attribute may include information or data (e.g., the pairing status between the electronic tether and the device 110, the product identification of the electronic tether, etc.) associated with the electric tether. In some examples, the device 110 may concatenate or combine the public key and the attribute(s) and send the combined information to the server system 310 or transmit the public key and the attribute(s) separately. In other examples, the device 110 may send either the public key or the attribute(s) to the server system 130.

In some examples, the device 110 may determine whether the public key is a valid key and transmit the public key to the server system 130 in response to the determination. In such examples, when the device 110 determines that the public key is not valid (e.g., due to a compromised key, a modified key, a private key not corresponding to the public key, a key received after a predetermined period of time, etc.), the device 110 may not transmit the public key. In other examples, the device 110 may forward the public key to the server system 130 without the determination. In such examples, the server system 130 may determine validity of the public key. In further examples, the server system 130 may assume that the public key is valid and encrypt data (e.g., a challenge) with the received public key. In such examples, the electronic tether 120 may evaluate the encrypted data based on a private kay.

At step 316, the server system 130 may perform policy evaluation based on the public key and/or the attribute to establish a verified connection between the device 110 and the server system 130. The server system 130 may determine whether the device is allowed to access the server system 130 during the policy evaluation. For example, the server system 130 may compare the user identification and the password received from the device with a password stored in the server system 130 corresponding to the user identification. In some examples, the server system 130 may include one server to perform policy evaluation and the session initiation process 300. In other example, the server system 130 may include a server to perform the session initiation process 300 and another server to perform the policy evaluation. In such examples, the server may query another server to perform the policy evaluation. Also, the policy evaluation may also evaluate the public key to determine whether the electronic tether 120 is allowed to be used to establish the verified connection between the device 110 and the server system 130. For example, the server system 130 may have the public key (e.g., via a pre-registration process) before the electronic tether 120 transmits the public key to the server system 130 via the device 110. Then, the server system 130 may compare the public key from the electronic tether 120 with the public key stored in the memory 214 of the server system 130. In some examples, the server system 130 may also perform policy evaluation based on an attribute (e.g., product identification, pairing connection status with the device, etc.) of the electronic tether 120.

In some examples, the policy evaluation may include the server system 130 additionally, or alternatively, verifying that the public key has been signed by a trusted certificate authority (e.g., a third party). For example, the server system 130 may verify that the public key has been signed by a trusted certificate authority (CA) by determining that the trusted CA has issued a signed digital certificate with a cryptographic link to the electronic tether 120 providing assurance that public key indeed corresponds to the electronic tether 120. To perform this determination, the system server 130 may use a CA digital certificate corresponding to the trusted CA and a digital certificate for the electronic tether 120 signed by the trusted CA. The signed digital certificate for the electronic tether 120 may include a public key and attributes (e.g., a name or identifier of the electronic tether 120) signed by the CA using a private key of the trusted CA. The system server 130 may perform a cryptographic operation using a public key of the trusted CA (from the CA digital certificate) to validate that the private key of the trusted CA indeed signed the digital certificate for the electronic tether 120.

Upon completing the policy evaluation (e.g., and determining that the device 110 may access the server system 130), the server system 130 may establish the verified connection 306 to the device 110 by allowing the device 110 to access the server system 130. For example, the verified connection 306 may be a communication channel or link between the device 110 and the server system 130 to communicate (e.g., transmit or receive data) with each other. With access to the server system 130 via the verified connection 306, the device 110 may have access to resources of the server system 130, such as, for example, a database(s), software application(s), etc.

In the connection validation process 304, the device 110 and/or the server system 130 may determine whether to maintain the verified connection 306. For example, the verified connection 306 may be maintained based on multiple periodic challenges transmitted from the server system 130 to the electronic tether 120 via the device 110 and a tether response from the electronic tether 120 to the server system 130 via the device 110 in response to a challenge of the multiple periodic challenges. The periodic challenges may occur at regular or irregular intervals.

At step 318, the server system 130 may generate or obtain a session key and transmit the session key and/or a first challenge among multiple periodically transmitted challenges to the device 110. Similarly, the device 110 may receive the first challenge among multiple periodically received challenges with or without the session key. The device 110 may receive the first challenge while the device 110 has the verified connection 306 to the server system. Each challenge, including the first challenge, may include any symbol(s), any character(s), any string, any number, or a combination thereof, which may also be referred to as challenge data. In some examples, the first challenge may be encrypted with the public key and sent by the server system 130 to the device 110. In further examples, the session key and the first challenge may be encrypted together with the public key. The session key may be a symmetric key used for encrypting data in one communication session or until the verified connection 306 is terminated.

At step 320, the device 110 may transmit the first challenge and/or the session key to the electronic tether 120. In some examples, the device 110 may forward the first challenge and/or the session key to the electronic tether 120. In other examples, the device 110 may determine whether the first challenge is a valid challenge from the server system 130. In such examples, when the device 110 determines that the first challenge is not valid (e.g., due to a challenge received after a predetermined period of time, a compromised challenge, etc.), the device 110 may not transmit the first challenge to the electronic tether 120.

At step 322, the electronic tether 120 may receive the first challenge and generate a tether response in response to the first challenge. For example, the electronic tether 120 may sign the first challenge with a private key to generate the tether response. The tether response may include any symbol(s), any character(s), any number, or a combination thereof which satisfies the first challenge. Thus, the tether response may be an answer to the first challenge. Because the private key is not stored in the server system 130 or communicated during the session (and may not be known by a device or entity other than the electronic tether 120), the private key may not be able to be stolen during communications among the electronic tether 120, the device 110, and the server system 130.

In some examples, the electronic tether 120 signing a challenge from the device 110 (e.g., the first challenge) may include appending cryptographic data to a challenge response, and the challenge response and the appended cryptographic data together form the tether response. Here, the challenge response may include, for example, (i) a copy of the challenge or portion thereof or (ii) a modified version of the challenge (or portion thereof) generated by the electronic tether 120 by applying, for example, a cryptographic hash or checksum function to the challenge (or portion thereof). The appended cryptographic data may include data that the electronic tether 120 generates with a signing function using the private key of the electronic tether 120 and the challenge (or other data known to the server system 130). In some examples, the modified version of the challenge includes a signature of the electronic tether 120 (e.g., generated via the private key of the electronic tether 120). For example, the electronic tether 120 may apply a signing algorithm to the challenge with the private key to generate the signed challenge response. Here, the signed challenge response may serve as both the challenge response and the cryptographic data of the tether response, and separate cryptographic data is not appended to the challenge response.

In some examples, the first challenge is a challenge encrypted (e.g., with the public key). As part of generating the tether response, the electronic tether 120 may decrypt the first challenge using the private key that corresponds to the public key. The tether response may then be based on or incorporate a portion of the (decrypted) first challenge (e.g., using the above-described techniques). Additionally, in some examples, after the tether response is generated by the electronic tether 120 (but before transmission), the electronic tether 120 encrypts the tether response with the private key or session key (e.g., received as part of the first challenge). Accordingly, the tether response may be an encrypted tether response. In some examples where the session key is shared between the server system 130 and the electronic tether 120 in advance of the first challenge, the session key may be used by the server system 130 to encrypt the first challenge and by the electronic tether 120 to decrypt the first challenge.

At step 324, the electronic tether 120 may transmit the tether response to the device 110. Similarly, the device 110 may receive the tether response from the electronic tether 120 where the tether response is a response to the first challenge. In some examples, the electronic tether 120 may encrypt the tether response, for example, using the private key or the session key received from the server system 130 via the device 110. In such examples, the electronic tether 120 may transmit the tether response encrypted with the private key or the session key. In some examples, the session key may be used for subsequent challenges and tether responses until the verified connection is terminated. Thus, the first challenge may be encrypted using asymmetric cryptography based on the public key and the private key in the electronic tether to enhance security due to two separate keys. But by using the symmetric cryptography, subsequent challenges and responses may use less computational power and may be processed faster than the first challenge. In other examples, asymmetric cryptography may be used for the multiple challenges and responses.

At step 326, the device 110 may transmit the tether response to the server system 130. Similarly, the server system 130 may receive the tether response from the device 110. In some examples, the device 110 may determine whether the tether response is a valid tether response and transmit the tether response to the server system 130 in response to the determination. In such examples, when the device 110 determines that the tether response is valid, the device may maintain the verified connection 306 by transmitting the tether response. However, when the device 110 determines that the tether response is an invalid response, the device 110 may not transmit the tether response and/or terminate the verified connection 306. For example, when the device 110 receives the tether response after a predetermined period of time, the device 110 may determine that the tether response is not valid. The predetermined time period may correspond to a distance or proximity threshold within which the electronic tether 120 is expected to remain to enable access to the server system 130. For example, as an electronic tether 120 moves further away from the device 110, the travel time of the challenge of step 320 and tether response of step 324 to wirelessly transit between devices increases. Thus, when the device 110 receives the tether response at step 324 after the predetermined period of time, the device 110 (or, ultimately, the server system 130) may determine (through inference) that the device 110 is not proximate to the device 110 (e.g., a distance between the electronic tether 120 and the device 110 exceeds the distance or proximity threshold). This time-based approach can, for example, assist the system to avoid a rebroadcast attack. Also, when the device 110 detects disconnection to the electronic tether 120 (e.g., detects a broken communication link or a strength of signal of a communication link below a threshold), the device 110 may determine the tether response is not valid. Alternatively or additionally, the device 110 may determine that the tether response is not valid due to an invalid session key, a compromised key, a modified tether response, a response, which is different from the tether response that was expected based on the first challenge, or any other suitable reason. In other examples, although the device 110 determines that the tether response is an invalid tether response, the device 110 may maintain the verified connection 306 and forward the invalid tether response until the device 110 receives a predetermined number of invalid tether responses. In some examples, the device 110 forwards the tether response to maintain the verified connection 306 without a substantive determination as to the validity of the tether response.

At step 328, the server system 130 may validate the tether response. For example, the tether response may be a signature on the first challenge. In such examples, the server system 130 may validate the tether response based on the first challenge and/or the public key received from the electronic tether 120. In some scenarios, the server system 130 may decrypt the tether response with the public key and calculate the hash of the first challenge to compare the hash with the decrypted tether response (e.g., a hash). When the two hashes match, the server system 130 may verify the tether response and maintain the verified connection 306. When the two hashes do not match, the server system 130 may determine that the tether response is an invalid response. In further examples, when the device 110 or the server system 130 receives the tether response after a predetermined period of time, the server system 130 may determine that the tether response is not valid. As noted above, the predetermined time period may correspond to a distance or proximity threshold within which the electronic tether 120 is expected to remain to enable access to the server system 130. For example, as an electronic tether 120 moves further away from the device 110, the travel time of the challenge of step 320 and tether response of step 324 to wirelessly transit between these devices increases. Thus, when the device 110 receives the tether response at step 324 after the predetermined period of time, the server system 130 may determine (through inference) that the device 110 is not proximate to the device 110 (e.g., a distance between the electronic tether 120 and the device 110 exceeds the distance or proximity threshold). In some examples, the device 110 may report to the server system 130 the time period between the device 110 transmitting the challenge at step 320 and receiving the tether response at step 324 such that the server system 130 may compare this time period to the predetermined time period to make the determination. This time-based approach can, for example, assist the system to avoid a rebroadcast attack. Alternatively or additionally, the server system 130 may determine that the tether response is not valid due to an invalid session key, a compromised key, a modified tether response, or any other suitable reason. In some examples, the server system 130 may terminate the verified connection upon the determination of the invalid response. In other examples, although the server system 130 determines that the tether response is an invalid tether response, the server system 130 may maintain the verified connection until the server system 130 receives a predetermined number of invalid tether responses. In some examples, the server system 130 terminates the verified connection in response to determining that no tether response or no valid tether response has not been received within a predetermined amount of time (e.g., since the challenge was transmitted).

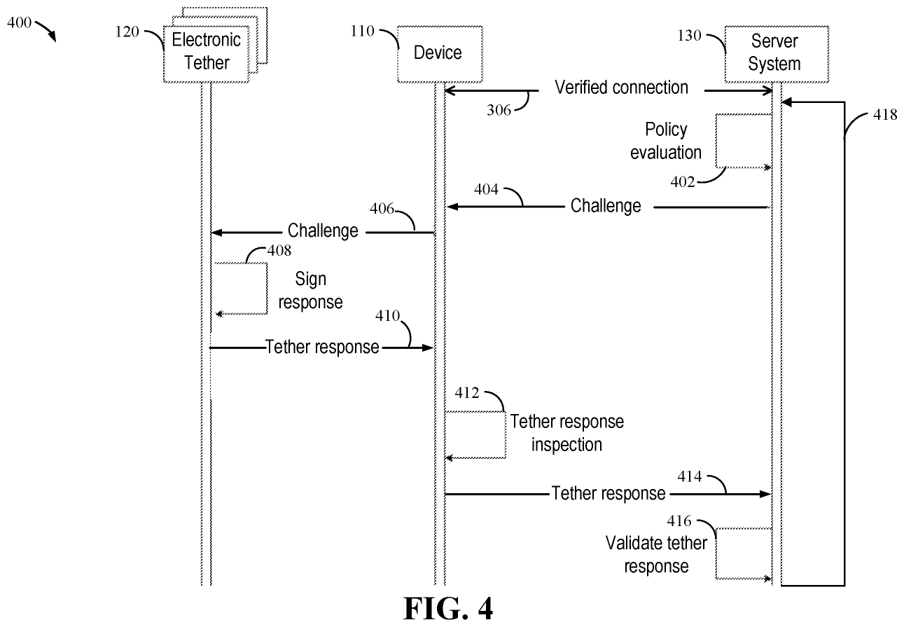

FIG. 4 is a flowchart to illustrate a process 400 for ongoing evaluation among an electronic tether, a device, and a server system according to some examples. As described below, a particular implementation may omit some or all illustrated features/steps, may be implemented in some embodiments in a different order, and may not require some illustrated features to implement all embodiments.

The ongoing evaluation process 400 may be similar to the connection validation process 304 of FIG. 3. The ongoing evaluation process 400 may be repeated periodically. As described further below, through repetition of the ongoing evaluation process 400, multiple periodically transmitted challenges may be provided by the server system 130 and may be received and provided by the device 110. Thus, the server system 130 may continuously evaluate authorization of the device to access the server system 130 based on proximity of the electronic tether 120 to the device 110. Also, the server system 130 may maintain the verified connection 306 or authorization of a remote connection to the server system based on the continuous evaluation of proximity to the electronic tether 120.

At step 402, the server system 130 may perform policy evaluation. Step 402 may be substantially similar to step 316 in FIG. 3. At step 402, the server system 130 may determine whether the verified connection 306, which is already established via the session connection establishment process 302 of FIG. 3, should remain established. In some examples, the server system 130 may perform policy evaluation based on the public key, the attribute of the device 110, and/or the attribute of the electronic tether 120. In the event that the server system 130 determines, via the policy evaluation, that the verified connection 306 should be terminated, the server system 130 may terminate the verified connection 306.

At step 404, the server system 130 may transmit a challenge of the multiple periodically transmitted challenges to the device 110. Similarly, the device 110 may receive the challenge of the multiple periodically received challenges from the server system 130. Step 404 may be similar to some or all of step 318 in FIG. 3. The device 110 may receive the multiple periodically received challenges while the device 110 has the verified connection 306 to the server system 130. Also, the device 110 may have already received the session key in the connection validation process 304 of FIG. 3. Thus, the server system 130 may transmit the challenge without the session key. In some examples, the challenge may be the same as the first challenge, which may be encrypted with the public key. In other examples, each challenge to be transmitted by the server system 130 may be different but may be encrypted with the same public key. In examples with multiple electronic tethers 120, described further below, the challenge to be transmitted for each electronic tether 120 may be different and/or may be encrypted with a different public key (e.g., the public key associated with the electronic tether 120 to which the challenge is to be transmitted). Additionally or alternatively, the server system 130 may encrypt the challenge with the session key. For example, the server system 130 may encrypt, with the session key, the challenge, which is already encrypted with the public key. In other examples, the server system 130 may encrypt, with the session key, the challenge, which is not encrypted with the public key. Then, the server system 130 may transmit and the device 110 may receive the challenge, which may be encrypted, as described.

At step 406, the device 110 may transmit the challenge to the electronic tether 120. Step 406 may be similar to step 320 in FIG. 3. While the device 110 transmits the challenge with the session key in step 320, the device 110 may transmit the challenge, which is encrypted with the session key in step 320. In other examples, the device 110 may transmit the challenge without being encrypted with the session key. Similar to step 320, the device 110 may forward the challenge or transmit the challenge after the device 110 determines that the challenge is a valid challenge to maintain the verified connection.

At step 408, the electronic tether 120 may receive the challenge and generate a tether response in response to the received challenge. Step 408 may be similar to some or all of step 322 in FIG. 3. For example, the electronic tether 120 may sign the challenge with the private key to generate the tether response, using similar techniques as described above. As part of generating the tether response, the electronic tether 120 may decrypt the challenge (e.g., using the private key or the session key). The tether response may then be based on or incorporate a portion of the (decrypted) challenge. In some examples, the electronic tether 120 may decrypt the challenge based on the session key received from the server system 130 at step 320 in FIG. 3. In such examples, the electronic tether 120 may further sign the challenge with the private key to generate the tether response.

At step 410, the electronic tether 120 may transmit the tether response to the device 110. Similarly, the device 110 may receive the tether response from the electronic tether 120. Step 410 may be similar to some or all of step 324 in FIG. 3. For example, in some examples, the tether response may be a response encrypted (e.g., with the session key or the private key).

At step 412, the device 110 may inspect the tether response. In some examples, the device 110 may determine whether the tether response is a valid tether response. In such examples, when the device 110 determines that the tether response is valid, the device may maintain the verified connection 306. However, when the device 110 determines that the tether response is an invalid response, the device 110 may terminate the verified connection 306. For example, when the device 110 receives the tether response after a predetermined period of time, the device 110 may determine that the tether response is not valid. The predetermined time period may correspond to a distance or proximity threshold within which the electronic tether 120 is expected to remain to enable access to the server system 130. For example, as an electronic tether 120 moves further away from the device 110, the travel time of the challenge of step 406 and tether response of step 410 to wirelessly transit between devices increases. Thus, when the device 110 receives the tether response at step 410 after the predetermined period of time, the device 110 (or, ultimately, the server system 130) may determine (through inference) that the device 110 is not proximate to the device 110 (e.g., a distance between the electronic tether 120 and the device 110 exceeds the distance or proximity threshold). This time-based approach can, for example, assist the system to avoid a rebroadcast attack. Also, the device 110 detects disconnection to the electronic tether 120, the device 110 may determine the tether response is not valid. Alternatively or additionally, the device 110 may determine that the tether response is not valid due to an invalid session key, a compromised key, a modified tether response, a response, which is different from the tether response that was expected based on the challenge, or any other suitable reason. In other examples, although the device 110 determines that the tether response is an invalid tether response, the device 110 may maintain the verified connection 306 until the device 110 receives a predetermined number of invalid tether responses. In some examples, the device 110 bypasses a tether response inspection in step 412, proceeding to step 414 (to forward the tether response to maintain the verified connection 306) without a substantive determination as to the validity of the tether response.

At step 414, the device may transmit the tether response to the server system 130. Similarly, the server system 130 may receive the tether response from the device 110. Step 414 may be similar to some or all of step 326 in FIG. 3. In some examples, the device may transmit the tether response even if the tether response is the invalid tether response.

At step 416, the server system 130 may validate the tether response. For example, the tether response may be a signature on the challenge, which is transmitted at step 404. Step 416 may be similar to some or all of step 328 in FIG. 3. When the server system 130 determines that the tether response is a valid response to the challenge, the server system 130 may maintain the verified connection 306. In some examples, the server system 130 terminates the verified connection in response to determining that a valid response has not been received by the device 110 and/or the server system 130 within a predetermined amount of time (e.g., since the challenge was transmitted) and/or in response to determining that a received tether response is an invalid tether response (e.g., as discussed with respect to step 328). For example, as discussed with respect to step 328, the predetermined time period may correspond to a distance or proximity threshold within which the electronic tether 120 is expected to remain to enable access to the server system 130. For example, as an electronic tether 120 moves further away from the device 110, the travel time of the challenge of step 406 and tether response of step 410 to wirelessly transit between these devices increases. Thus, when the device 110 receives the tether response at step 324 after the predetermined period of time, the server system 130 may determine (through inference) that the device 110 is not proximate to the device 110 (e.g., a distance between the electronic tether 120 and the device 110 exceeds the distance or proximity threshold). In some examples, the device 110 may report to the server system 130 the time period between the device 110 transmitting the challenge at step 406 and receiving the tether response at step 410 such that the server system 130 may compare this time period to the predetermined time period to make the determination. This time-based approach can, for example, assist the system to avoid a rebroadcast attack.

At step 418, if the server system 130 maintains the verified connection 306, the server system 130 may repeat steps 402-416 and transmit another challenge. In some examples, the server system 130 may periodically transmit challenges or the device 110 may periodically receive challenges at a particular frequency or at irregular intervals. For example, the server system 130 may transmit and the device 110 may receive a challenge once per time period or interval, where that time period or interval is 1 second, 5 seconds, 10 seconds, 30 seconds, 1 minute, 2 minutes, 5 minutes, or another value. The shorter the time period or interval, the more quickly a theft or separation from the electronic tether 120 may be detected, and the longer the time period or interval, the less computing and network resources that may be used. In other examples, the period may be determined or dynamically adjusted based on various factors (e.g., the battery level of the device 110 or the electronic tether, a use preference, a location, a type of communication network, etc.).

FIG. 5 is a flowchart illustrating a method of a device for tethering-based secure remote connections according to some examples. The method 500 is described as being performed by the device 110 and, in particular, a processing system 117 including the electronic processor 112 that is coupled with the memory 114 and/or the network interface 116. However, as noted above, the functionality described with respect to the method 500 may be performed by other suitable devices. As described below, a particular implementation may omit some or all illustrated features/steps, may be implemented in some embodiments in a different order, and may not require some illustrated features to implement all embodiments.

In block 505 of the method 500, the processing system 117 of the device 110 receives a first challenge of multiple periodically received challenges where the first challenge is received via a verified connection to a server system (e.g., the server system 130 of FIGS. 1-4). In some examples, block 505 is substantially similar to some or all of step 318 of FIG. 3 or 404 of FIG. 4. In some examples, prior to block 505, the processing system 117 may receive a public key from an electronic tether (e.g., the electronic tether 120 of FIGS. 14) (see step 312 of FIG. 3) and transmit the public key and an attribute to the server system (see step 314 of FIG. 3). The multiple periodically received challenges may be based on the public key and the attribute (e.g., attribute(s) of the device 110 and/or attribute(s) of the electronic tether) and may be received via the verified connection. For example, the first challenge of the multiple challenges may be an encrypted challenge based on the public key. The verified connection may be established using the secure connection establishment process 302 of FIG. 3. The multiple periodically received challenges is described in connection with step 418 of FIG. 4. Also, the processing system 117 of the device 110 may further receive a session key for the verified connection from the server system 130 and transmit the session key to the electronic tether 120 (see step 318 and 320 of FIG. 3). In some examples, the session key may be an encrypted session key based on the public key.

In block 510 of the method 500, the processing system 117 transmits, wirelessly, the first challenge to the electronic tether 120. In some examples, block 510 is substantially similar to some or all of step 320 of FIG. 3 or 406 of FIG. 4.

In block 515 of the method 500, the processing system 117 receives, from the electronic tether 120, a tether response to the first challenge. In some examples, block 515 is substantially similar to some or all of step 324 of FIG. 3 or 410 of FIG. 4.

In block 520 of the method 500, the processing system 117 maintains the verified connection by transmitting the tether response to the server system 130. In some examples, block 520 is substantially similar to some or all of step 326 of FIG. 3 or steps 412 and 414 of FIG. 4.

In some examples, the processing system 117 may further receive a second challenge of the multiple periodically received challenges from the server system 130 where the second challenge is received while the processing system 117 has the verified connection to the server system 130. Then the processing system 117 may transmit the second challenge for the electronic tether 120, and lose the verified connection to the server system 130 in response to failing to transmit a second tether response to the server system 130 that is expected based on the second challenge (see step 326 of FIG. 3 or 412 or 414 of FIG. 4).

In some examples, the processing system 117 may receive an invalid tether response to the second challenge and transmit the invalid tether response to the server system 130 (see step 326 of FIG. 3 or steps 412 and 414 of FIG. 4). In other examples, in response to the invalid tether response, the processing system 117 may not transmit the invalid tether response to the server system. The verified connection that was lost may be terminated in response to the invalid tether response being different than the second tether response that was expected based on the second challenge. For example, the verified connection may be terminated by the device 110 or the server system. In other examples, the processing system 117 may terminate the verified connection, causing the verified connection to be lost, in response to failing to receive the second tether response from the electronic tether within a predetermined period of time (see step 326 of FIG. 3 or step 412 of FIG. 4).

FIG. 6 is a flowchart illustrating a method of a server for tethering-based secure remote connections according to some examples. The method 600 is described as being performed by the server system 130 and, in particular, a processing system 217 including the electronic processor 212 coupled with the memory 214 and/or the network interface 216. However, as noted above, the functionality described with respect to the method 600 may be performed by other suitable devices. As described below, a particular implementation may omit some or all illustrated features/steps, may be implemented in some embodiments in a different order, and may not require some illustrated features to implement all embodiments.

In block 605 of the method 600, the processing system 217 of the server system 130 establishes a verified connection to a device (e.g., the device 110 of FIGS. 1-4). In some examples, the verified connection may be established using the secure connection establishment process 302 of FIG. 3. In some examples, prior to block 605, the processing system 217 may receive a public key and/or an attribute (see step 314 of FIG. 3). In such examples, the verified connection may be established based on the public key and the attribute.

In block 610 of the method 600, the processing system 217 of the server system 130 periodically transmits multiple challenges to an electronic tether (e.g., the electronic tether 120 of FIGS. 1 and 34). In some examples, block 610 is substantially similar to some or all of step 318 of FIG. 3 or 404 of FIG. 4. The multiple challenges, which are periodically transmitted, are described in connection with step 418 of FIG. 4. For example, the server system 130 may transmit and the device 110 may receive the multiple challenges, where the time period or interval between challenges is less than ten seconds. However, the period between challenges may be any suitable period (e.g., 1 second, 2 seconds, 5 seconds, 30 seconds, 1 minute, 5 minutes, etc.). In some examples, the processing system 217 may transmit a first challenge of the multiple challenges with or without a session key for the verified connection to the electronic tether via the device. The first challenge and/or the session key may be encrypted based on the public key.

In block 615 of the method 600, the processing system 217 of the server system 130 receives a tether response from the electronic tether based on a first challenge of the multiple challenges. In some examples, block 615 is substantially similar to some or all of step 326 of FIG. 3 or 414 of FIG. 4. Also, the tether response may be an encrypted response based on the session key.

In block 620 of the method 600, the processing system 217 of the server system 130 maintains the verified connection to the device based on the tether response. In some examples, block 620 is explained in connection with step 328 of FIG. 3 or step 416 of FIG. 4.

In some examples, the processing system 217 of the server may transmit a second challenge of the multiple challenges where the second challenge is transmitted via the verified connection to the device. In some scenarios, the processing system 217 may terminate the verified connection to the device in response to failing to receive a second tether response based on the second challenge within a predetermined period of time. In other scenarios, the processing system 217 may receive an invalid tether response to the second challenge and terminate the verified connection to the device in response to the invalid tether response (see step 326 of FIG. 3 or step 416 of FIG. 4).

In some examples of the process 300, process 400, method 500, and/or method 600, the device 110 and verified connection 306 with the server system 130 is associated with, and secured by, multiple electronic tethers 120. For example, the server system 130 may generate challenges, via the device 110, to multiple electronic tethers 120, and may receive (via the device 110) and evaluate tether responses from the multiple electronic tethers 120. The device 110 and/or the server system 130 may then maintain or terminate the verified connection based on evaluation of the tether responses. For example, in some examples, the server system 130 may terminate the verified connection 306 if a valid tether response is not received from one of the electronic tethers 120, or a certain number of electronic tethers 120 (e.g., two, three, a majority, or a certain percentage of the electronic tether 120). Accordingly, in some examples, a separate instance of the process 300 and/or 400 may be performed by the device 110 and the server system 130 for each electronic tether 120 (e.g., performed in parallel or in an overlapping manner). Similarly, in some examples, a separate instance of the method 500 may be performed by the device 110 for each electronic tether 120 (e.g., performed in parallel or in an overlapping manner). Similarly, in some examples, a separate instance of the method 600 may be performed by the server system 130 for each electronic tether 120 (e.g., performed in parallel or in an overlapping manner). Accordingly, as an example, a verified connection between the device 110 and the server system 130 may be established and maintained conditioned on the device 110 being in proximity to multiple electronic tethers 120, and, when one or a certain number of the electronic tethers 120 become spatially separated from the device 110, the verified connection may be terminated (e.g., by the device 110 and/or server system 130, as described with respect to FIGS. 4-6).

In some examples, aspects of the technology, including computerized implementations of methods according to the technology, may be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology may be implemented as a set of instructions, tangibly embodied on a non-transitory computer-readable media, such that a processor device may implement the instructions based upon reading the instructions from the computer-readable media. Some examples of the technology may include (or utilize) a control device such as, e.g., an automation device, a special purpose or general-purpose computer including various computer hardware, software, firmware, and so on, consistent with the discussion below. As specific examples, a control device may include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, may be represented schematically in the figures, or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, may be executed in different orders than are expressly illustrated or described, as appropriate for particular examples of the technology. Further, in some examples, certain operations may be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer may be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that may be present in any variety of combinations, rather than an exclusive list of components that may be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

Although the present technology has been described by referring to preferred examples, workers skilled in the art will recognize that changes may be made in form and detail without departing from the scope of the discussion.

What is claimed is:

1. A device, comprising:
a network interface; and
a processing system including an electronic processor, wherein the processing system is to:
receive, via the network interface, a first challenge of a plurality of periodically received challenges from a server system, the first challenge being received while the processing system has a verified connection to the server system via the network interface;
transmit, wirelessly, the first challenge to an electronic tether;
receive, from the electronic tether, a tether response to the first challenge; and
maintain the verified connection by transmitting, via the network interface, the tether response to the server system.

2. The device of claim 1, wherein the processing system is to:
receive, via the network interface, a second challenge of the plurality of periodically received challenges from the server system, the second challenge being received while the processing system has the verified connection to the server system;
transmit, wirelessly, the second challenge for the electronic tether; and
lose the verified connection to the server system in response to failing to transmit a second tether response to the server system that is expected based on the second challenge.

3. The device of claim 2, wherein the processing system is to
receive, via the network interface, an invalid tether response to the second challenge; and
transmit, via the network interface, the invalid tether response to the server system, and
wherein the verified connection that was lost is terminated in response to the invalid tether response being different than the second tether response that was expected based on the second challenge.

4. The device of claim 2, wherein the processing system is to
terminate the verified connection, causing the verified connection to be lost, in response to failing to receive the second tether response from the electronic tether within a predetermined period of time.

5. The device of claim 1, wherein the processing system is to:
receive, via the network interface, a public key from the electronic tether; and
transmit, via the network interface, the public key and an attribute to the server system,
wherein the plurality of periodically received challenges from the server system are based on the public key and the attribute.

6. The device of claim 5, wherein the first challenge is an encrypted challenge based on the public key.

7. The device of claim 5, wherein the processing system is to:
receive, via the network interface, a session key for the verified connection; and
transmit, via the network interface, the session key to the electronic tether.

8. The device of claim 7, wherein the session key is an encrypted session key based on the public key, and
wherein the tether response is an encrypted response based on the session key.

9. A method, comprising:
receiving a first challenge of a plurality of periodically received challenges from a server system, the first challenge received via a verified connection to the server system;
transmitting, wirelessly, the first challenge to an electronic tether;
receiving, from the electronic tether, a tether response to the first challenge; and
maintaining the verified connection by transmitting the tether response to the server system.

10. The method of claim 9, further comprising:
receiving a second challenge of the plurality of periodically received challenges from the server system, the second challenge being received upon the verified connection to the server system;
transmitting, wirelessly, the second challenge for the electronic tether; and
losing the verified connection to the server system in response to failing to transmit a second tether response to the server system that is expected based on the second challenge.

11. The method of claim 10, further comprising:
receiving an invalid tether response to the second challenge; and
transmitting the invalid tether response to the server system, and
wherein the verified connection that was lost is terminated in response to the invalid tether response being different than the second tether response that was expected based on the second challenge.

12. The method of claim 10, further comprising:
terminating the verified connection, causing the verified connection to be lost, in response to failing to receive the second tether response from the electronic tether within a predetermined period of time.

13. The method of claim 9, further comprising:
receiving a public key from the electronic tether; and
transmitting the public key and an attribute to the server system,
wherein the plurality of periodically received challenges from the server system are based on the public key and the attribute.

14. The method of claim 9, wherein an interval between challenges of the plurality of periodically received challenges is less than ten seconds.

15. A server system, comprising:
a processing system including an electronic processor,
wherein the processing system is to:
establish a verified connection to a device;
periodically transmit a plurality of challenges to an electronic tether being wirelessly coupled to the device via the device using the verified connection to the device;
receive a tether response from the electronic tether based on a first challenge of the plurality of challenges; and
maintain, based on the tether response, the verified connection to the device.

16. The server system of claim 15, wherein the processing system is to:
transmit a second challenge of the plurality of challenges, the second challenge being transmitted via the verified connection to the device; and
terminate the verified connection to the device in response to failing to receive a second tether response based on the second challenge within a predetermined period of time.

17. The server system of claim 15, wherein the processing system is to
transmit a second challenge of the plurality of challenges, the second challenge being transmitted via the verified connection to the device;
receive an invalid tether response to the second challenge; and
terminate the verified connection to the device in response to the invalid tether response.

18. The server system of claim 15, wherein an interval between challenges of the plurality of periodically received challenges is less than ten seconds.

19. The server of claim 15, wherein the processing system is to:
receive a public key from the electronic tether via the device;
receive an attribute of the device; and
establish the verified connection to the device based on the public key and the attribute.

20. The server system of claim 19, wherein the processing system is to:
transmit a session key for the verified connection to the electronic tether via the device,
wherein the session key is an encrypted session key based on the public key, and
wherein the tether response is an encrypted response based on the session key.
